(19) United States
(12) Patent Application Publication
(10) Pub. No.: US 2015/0081479 A1
(43) Pub. Date: Mar. 19, 2015

(54) SYSTEM AND SOFTWARE FOR DETERMINING TAXABLE SALES BASED UPON INVENTORY

(71) Applicant: Monte Brown, Omaha, NE (US)

(72) Inventor: Monte Brown, Omaha, NE (US)

(21) Appl. No.: 14/187,463

(22) Filed: Feb. 24, 2014

Related U.S. Application Data
(60) Provisional application No. 61/879,335, filed on Sep. 18, 2013.

(51) Int. Cl. G06Q 40/00; G06Q 10/08

(52) U.S. Cl. CPC G06Q 40/10; G06Q 10/087
USPC 705/28

(57) ABSTRACT

A system for determining sales tax based upon inventory includes a processor configured to receive inventory information associated with goods stocked by a merchant. The system also includes a memory having computer executable instructions stored thereon. The computer executable instructions are configured for execution by the processor to determine an amount of taxable sales made by the merchant based upon the inventory information.

### CROSS-REFERENCE TO RELATED APPLICATIONS

The present application claims the benefit under 35 U.S.C. §119(e) of U.S. Provisional Application Ser. No. 61/879,335 filed Sep. 18, 2013, entitled “SYSTEM AND SOFTWARE FOR TRACKING SALES TAX BASED ON INVENTORY” which is herein incorporated by reference in its entirety.

### BACKGROUND

Merchants trade in commodities, such as goods and services produced by others. Retail merchants (retailers) sell commodities to end-users (consumers), including individual consumers and businesses, usually in small quantities. For example, a convenience store is an example of a retailer that stocks everyday items, such as groceries, toiletries, alcoholic drinks, soft drinks, candy products, tobacco products, newspapers, and so forth. Wholesale merchants (wholesalers) operate between producers and retailers, typically dealing in large quantities of goods. For instance, wholesalers are involved in the resale of new and used goods to retailers; industrial, commercial, institutional, and professional users; other wholesalers; and so on. Oftentimes, wholesalers organize the movement of goods between producers and retailers, rather than moving the goods themselves.

### SUMMARY

A system for determining sales tax based upon inventory includes a processor configured to receive inventory information associated with goods stocked by a merchant. The system also includes a memory having computer executable instructions stored thereon. The computer executable instructions are configured for execution by the processor to determine an amount of taxable sales made by the merchant based upon the inventory information.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DRAWINGS

The Detailed Description is described with reference to the accompanying figures. The use of the same reference numbers in different instances in the description and the figures may indicate similar or identical items.

FIG. 1 is a block diagram illustrating a system configured to determine taxable sales made by a merchant based upon the merchants' inventory in accordance with example embodiments of the present disclosure.

FIG. 2 is a diagrammatic illustration of a period during which taxable sales are made by a merchant in accordance with example embodiments of the present disclosure.

FIG. 3 is a block diagram illustrating a system configured to determine taxable sales made by a merchant based upon the merchants' inventory, such as the system illustrated in FIG. 1, where the system is connected to a network and one or more client devices in accordance with example embodiments of the present disclosure.

FIG. 4 is a flow diagram illustrating a method for determining taxable sales made by a merchant based upon the merchants' inventory in accordance with example embodiments of the present disclosure.

### DETAILED DESCRIPTION

Aspects of the disclosure are described more fully hereinafter with reference to the accompanying drawings, which form a part hereof, and which show, by way of illustration, example features. The features can, however, be embodied in many different forms and should not be construed as limited to the combinations set forth herein; rather, these combinations are provided so that this disclosure will be thorough and complete, and will fully convey the scope. Among other things, the features of the disclosure can be facilitated by methods, devices, and/or embodied in articles of commerce. The following detailed description is, therefore, not to be taken in a limiting sense.

Sales tax is a tax paid to a governing body for sales of goods and services. Retailers are typically required to collect conventional or retail sales tax levied on the sale of goods or services to consumers. Sales tax is charged every time a particular good or service is sold at retail. Generally, laws allow or require the seller to collect funds for sales tax from consumers at the point of purchase. Some laws allow retailers to itemize sales tax separately from the price of goods and services. Other laws require sales tax to be included in the price of the goods and services. The sales tax amount is typically calculated by applying a percentage rate to the taxable price of a sale. Some laws provide for the exemption of goods or services from sales tax.

Generally, businesses who later resell goods are not charged sales tax. For instance, a purchaser who is not an end-user can be issued a “resale certificate” by a taxing authority and required to provide the certificate (or its identification number) to a seller at the point of purchase, along with a statement that the item is for resale. Otherwise, sales tax is charged on each item sold to purchasers who do not provide such a certificate, and who are under the jurisdiction of the taxing authority. Other types of sales taxes include, but are not necessarily limited to: manufacturers' sales taxes levied on sales of tangible personal property by manufacturers and producers; wholesale sales taxes levied on wholesale sales of tangible personal property packaged, labeled, and ready for shipment or delivery to consumers; gross receipts taxes levied on all sales of a business; excise taxes imposed on the producer or wholesaler rather than the retail seller; value added taxes charged on all sales (thus avoiding the need for resale certificates); and so forth.

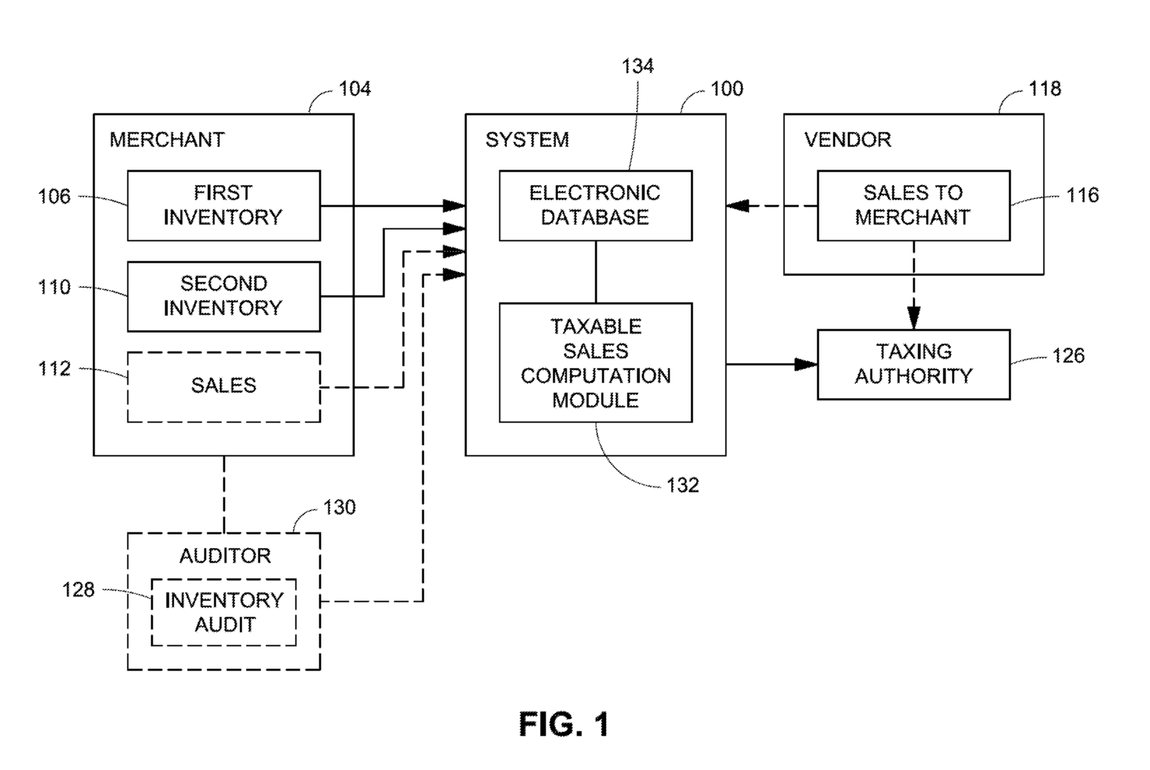

Referring generally to FIGS. 1 through 4, systems and techniques are described for determining an amount of taxable sales made by a merchant based upon the merchant's inventory. In embodiments of the disclosure, inventory information is provided by the merchant and includes, but is not necessarily limited to, inventory information provided by the merchant at the beginning of a period (e.g., at the beginning of a month) and inventory information provided by the merchant at the end of the period (e.g., at the end of the month). In some embodiments, the inventory information provided by the merchant also includes sales data (e.g., total sales during a period and/or taxable sales during a period). Additionally, in some embodiments, sales to a merchant during a period are reported by one or more vendors that supply inventory to the merchant.

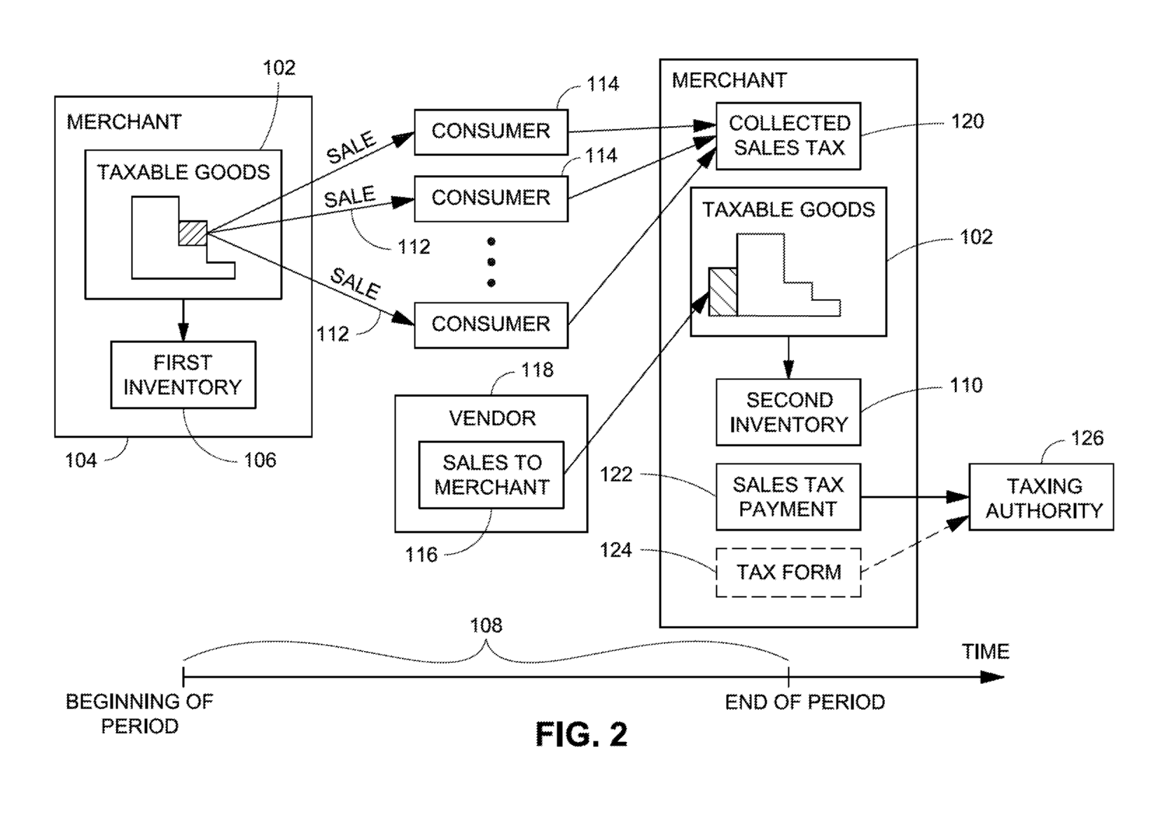

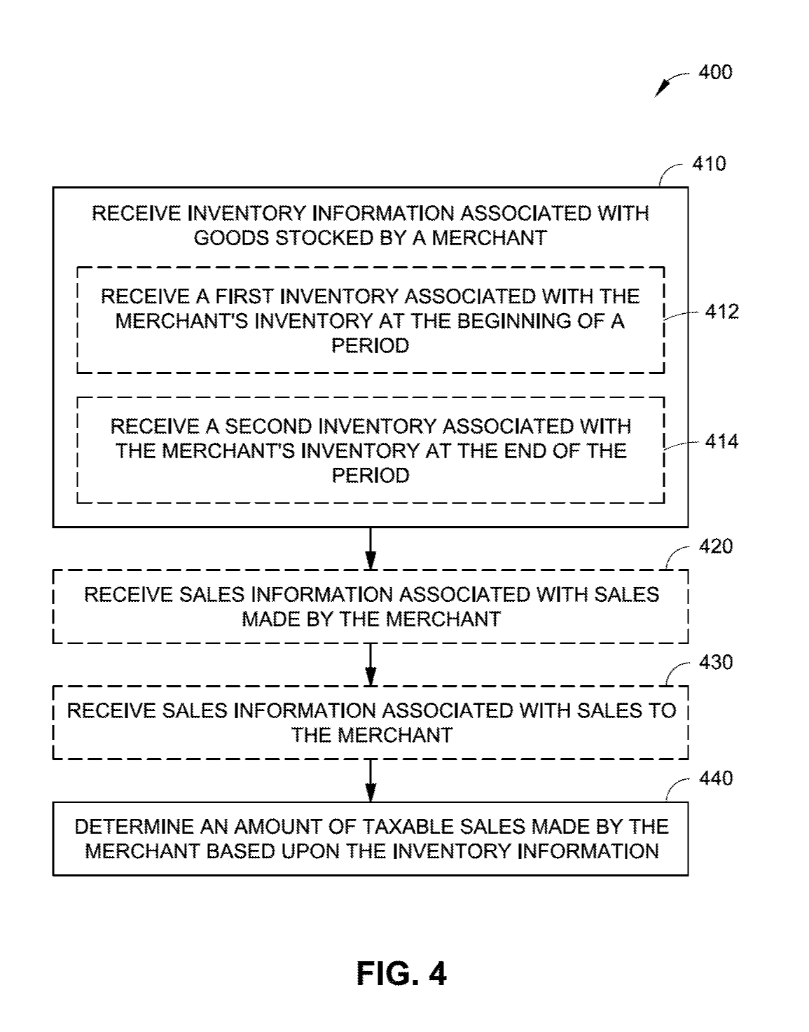

With reference to FIG. 4, a procedure 400 in accordance with example embodiments of the present disclosure includes receiving inventory information associated with goods stocked by a merchant (Block 410). For example, with reference to FIGS. 1 and 2, a system 100 receives inventory information associated with taxable goods 102 stocked by a merchant 104 (e.g., a retailer, a retail sales tax permit holder, etc.). In some embodiments, a first inventory is received that is associated with the merchant's inventory at the beginning of a period (Block 412). For instance, a first inventory 106 is submitted by the merchant 104 at the beginning of a period 108 (e.g., at the beginning of a month). Then, a second inventory is received that is associated with the merchant's inventory at the end of the period (Block 414). For example, a second inventory 110 is submitted by the merchant 104 at the end of the period 108 (e.g., at the end of the month).

In some embodiments, sales information is also received that is associated with sales made by the merchant (Block 420). For instance, the system 100 receives sales information associated with sales 112 made by the merchant 104 to consumers 114. The sales information can be associated with sales made, for example, by the merchant 104 during the period 108. Additionally, in some embodiments, sales information is received that is associated with sales to the merchant (Block 420). For example, the system 100 receives sales information associated with sales 116 to the merchant made by a vendor 118. The sales information can be associated with sales made, for instance, to the merchant 104 by the vendor 118 during the period 108. In some embodiments, the vendor 118 provides the system 100 with a copy of each receipt associated with the delivery of commodities to the merchant 104. In embodiments of the disclosure, the merchant 104 collects sales tax 120 from the consumers 114 during the period 108, and makes a sales tax payment 122 for the period 108 (possibly submitted with a tax form 124) to a taxing authority 126 (e.g., a city government, a state government, a federal government, and so on) subsequent to the period 108.

In an example, a convenience store retailer has thirty-six (36) cartons of a particular brand of taxable cigarette in stock at the beginning of a month. At the end of the month, the convenience store has thirty-two (32 cartons) of the cigarette brand in stock. During the month, the convenience store purchases and receives an additional fifteen (15) cartons of the cigarette brand from the vendor 118. Further, the convenience store sells nineteen (19) cartons of the cigarette brand during the month. The convenience store submits a first inventory 106 including the thirty-six (36) cartons of cigarettes and a second inventory 110 including the thirty-two (32) cartons of cigarettes to the system 100 (and possibly sales 112 including the nineteen (19) cartons of cigarettes). Additionally, the vendor who sold the convenience store the additional cartons of cigarettes can submit sales 116 including the fifteen (15) cartons of cigarettes to the system 100.

Next, an amount of taxable sales made by the merchant is determined based upon the inventory information (Block 440). For example, with continuing reference to the example above, when the system 100 receives the first inventory 106 including the thirty-six (36) cartons of cigarettes and the second inventory 110 including the thirty-two (32) cartons of cigarettes, the system 100 determines that at least four (4) cartons of the cigarette brand were sold during the month (36−32=4). In some embodiments, the amount of taxable sales made by the merchant includes the number of individual units (e.g., stock keeping units (SKUs)) sold by the merchant and associated identifying information for the units, including, but not necessarily limited to: SKU information, identification number (ID number) information, a general description (e.g., cigarettes or soda), a number of individual components (e.g., a number of individual cigarettes or cigarette packs in a carton, or a number of individual cans of soda in a case of soda), and so forth. Continuing the present example, the system 100 determines that an amount of at least four (4) units of inventory of the cigarette brand cartons was sold during the month.

In other embodiments, the amount of taxable sales made by the merchant includes the number of individual units (e.g., SKUs) sold by the merchant and monetary value associated with each unit, including, but not necessarily limited to: the price of each unit, the tax collected per unit, and so on. For instance, the system 100 determines that an amount of at least four (4) units of inventory was sold during the month at a price of thirty dollars ($30) per unit. In another example, the system 100 determines that an amount of at least four (4) units of inventory was sold during the month with sales tax of six dollars ($6) per unit. In further embodiments, the amount of taxable sales made by the merchant includes a number of units sold by the merchant (e.g., when the merchant sells primarily or exclusively one particular unit or type of unit), and not necessarily a number of individual units sold. In other embodiments, the amount of taxable sales made by the merchant includes a monetary value, such as a total amount of tax collected during a period, a total price of units sold during a period, and so forth, and not necessarily a number of individual units sold.

In a further example, when the system 100 receives the first inventory 106 including the thirty-six (36) cartons of cigarettes, the second inventory 110 including the thirty-two (32) cartons of cigarettes, and sales 112 including the nineteen (19) cartons of cigarettes, the system 100 determines that the nineteen (19) cartons of cigarettes indicated by sales 112 corresponds to the at least four (4) cartons of cigarettes sold during the month as determined above. In some embodiments, the system 100 determines that an amount of at least four (4) units of inventory of the cigarette brand cartons was sold during the month. In other embodiments, the system 100 determines that an amount of nineteen (19) units of inventory of the cigarette brand cartons was sold during the month. In instances where sales 112 does not correspond to the at least four (4) cartons of cigarettes sold during the month as determined above (e.g., sales 112 of fewer than four (4) cartons of cigarettes), the system 100 can determine that the larger amount (e.g., four (4) units of inventory of the cigarette brand cartons) was sold during the month.

In a further example, when the system 100 receives the first inventory 106 including the thirty-six (36) cartons of cigarettes, the second inventory 110 including the thirty-two (32) cartons of cigarettes, sales 112 including the nineteen (19) cartons of cigarettes, and sales 116 including the fifteen (15) cartons of cigarettes, the system 100 determines that nineteen (19) cartons of the cigarette brand were sold during the month (36−32+15=19). In this example, the nineteen (19) cartons of cigarettes indicated by sales 112 corresponds to the nineteen (19) cartons of cigarettes determined using the first inventory 106, the second inventory 110, and sales 116. In instances where sales 112 does not correspond to the nineteen (19) cartons of cigarettes sold during the month as determined above (e.g., sales 112 of more or less than nineteen (19) cartons of cigarettes), the system 100 can determine that the larger amount (e.g., nineteen (19) or more than nineteen (19) units of inventory of the cigarette brand cartons) was sold during the month.

In some embodiments, an inventory audit 128 of the taxable goods 102 is conducted by an auditor 130 and received by the system 100. The inventory audit 128 can be used to determine whether there is a discrepancy in the inventories reported by the merchant 104. For instance, in the example where the convenience store submits the first inventory 106 including thirty-six (36) cartons of cigarettes, the second inventory 110 including thirty-two (32) cartons of cigarettes, and sales 112 including nineteen (19) cartons of cigarettes, and the vendor submits sales 116 including fifteen (15) cartons of cigarettes, if the inventory audit 128 finds more than fifty-one (51) cartons of the particular brand of taxable cigarette in stock at any time during the period 108, there is a discrepancy in the inventories 106 and 110 reported by the convenience store, as the maximum number of cartons of cigarettes in stock during the period 108 should be fifty-one (51) according to the first inventory 106 and the sales 116 (36+15=51). The discrepancy can be reported to the taxing authority 126. It should be noted that in some embodiments performing the inventory audit 128 is less resource intensive (e.g., as compared to performing a sales audit).

In embodiments of the disclosure, the amount of taxable sales made by the merchant 104 and determined based upon the inventory information is provided to the taxing authority 126 by the system 100. The taxing authority 126 can compare the amount of taxable sales to the sales tax payment 122 and/or the tax form 124 to determine whether the merchant 104 has submitted an appropriate amount of sales tax. For example, by comparing the amount of taxable sales determined by the system 100 to the sales tax payment 122, the taxing authority 126 can verify that all of the collected sales tax 120 has been paid to the taxing authority 126. In other embodiments, the system 100 provides the amount of taxable sales made by the merchant 104 and determined based upon the inventory information to the merchant 104. For example, the system 100 generates a tax form (e.g., Nebraska Form 10 filing data generated using sales data, purchases data, and inventory data) for the merchant 104. It should be noted that Nebraska Form 10 filing data is provided by way of example only and is not meant to limit the present disclosure. In other embodiments, filing data is generated for other taxing authorities (e.g., one or more other state authorities, a federal government authority, and so forth).

The system 100 includes a taxable sales computation module 132. The taxable sales computation module 132 is configured to determine the amount of taxable sales made by a merchant based upon inventory information (e.g., as described above). In some embodiments, the system 100 includes an electronic database 134 coupled with the taxable sales computation module 132 to facilitate determination of the amount of taxable sales made by the merchant. For example, the electronic database 134 is configured to store information provided by the merchant 104, the vendor 118, the taxing authority 126, and so forth. Further, the electronic database 134 can store additional information, including, but not necessarily limited to: percentage rates applicable to the taxable price of a sale (e.g., sales tax rates, manufacturers' sales tax rates, wholesale sales tax rates, gross receipts tax rates, excise tax rates, value added tax rates, etc.), information identifying goods or services that are exempt from sales taxes, receipts associated with the delivery of commodities, identifying information associated with inventory (e.g., SKUs, ID numbers, general descriptions of inventory, numbers of individual components associated with inventory, etc.), monetary value associated with inventory (e.g., price per unit, tax per unit, etc.), information used to generate various tax forms, and so forth. It should be noted that while the taxable sales computation module 132 and the electronic database module 134 have been described with some specificity, these modules are provided by way of example only and are not meant to limit the present disclosure. Thus, in other embodiments, modules facilitating different functionality can be provided.

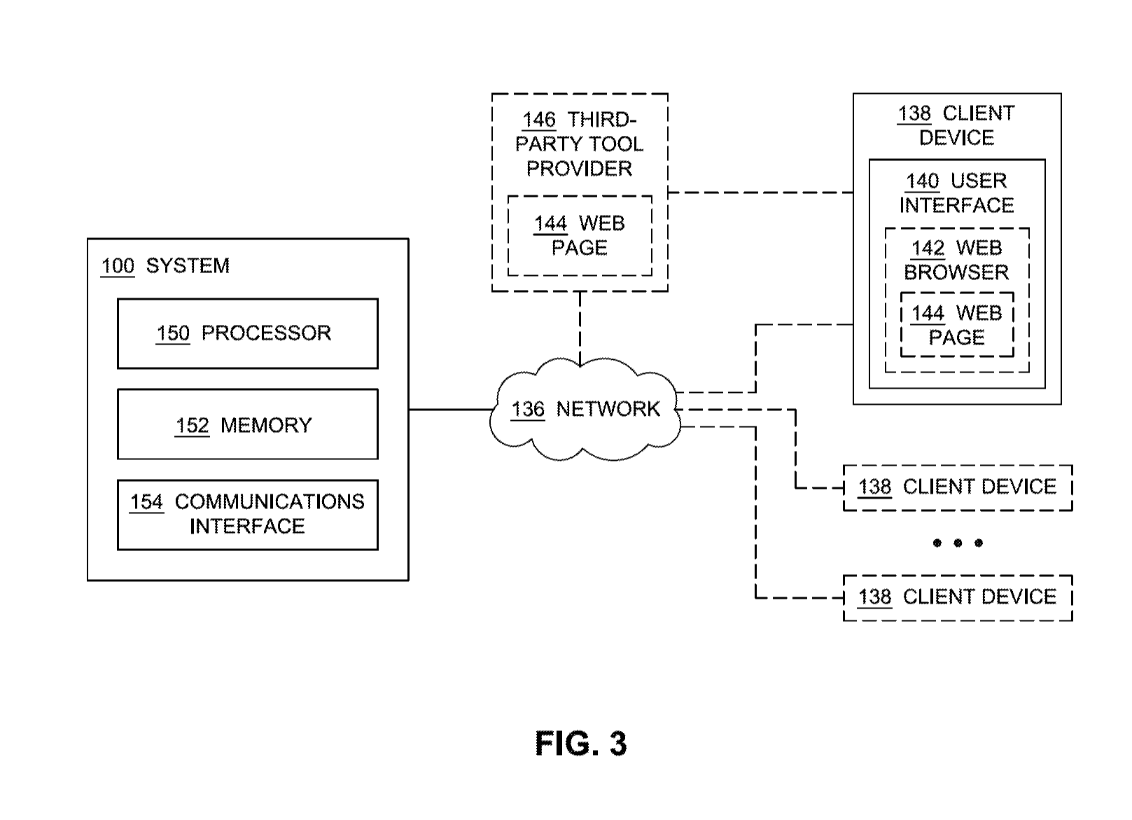

Referring now to FIG. 3, the system 100 is configured to connect to a network 136 and provide one or more client devices 138 with a user interface 140. The user interface 140 is configured to provide functionality for submitting inventory information, submitting sales information, submitting inventory audit information, receiving tax form information, receiving an amount of taxable sales, and so forth, to a merchant, a vendor, an auditor, and/or a taxing authority. A client device 104 can be an information handling system device, including, but not necessarily limited to: a mobile computing device (e.g., a hand-held portable computer, a personal digital assistant (PDA), a laptop computer, a netbook computer, a tablet computer, and so forth), a mobile telephone device (e.g., a cellular telephone, a smartphone), a device that includes functionalities associated with smartphones and tablet computers (e.g., a phablet), a portable game device, a portable media player device, a multimedia device, an e-book reader device (eReader), a smart television (TV) device, a surface computing device (e.g., a table top computer), a personal computer (PC) device, and so forth. One or more client devices 138 can be associated with a merchant, a vendor, an auditor, and/or a taxing authority. A merchant, a vendor, an auditor, and/or a taxing authority can communicate with the system 100 via a client device 104.

In some embodiments, a system 100 provides on demand software, e.g., in the manner of software as a service (SaaS) distributed to a client device 104 via the network 136 (e.g., the Internet). For example, a system 100 hosts inventory entry and/or tax form generation software and associated data in the cloud. The software is accessed by the client device 104 with a thin client (e.g., via a web browser 142). A merchant, a vendor, an auditor, and/or a taxing authority interfaces with the software (e.g., a web page 144) provided by the system 100 via the user interface 140 (e.g., using web browser 142). In embodiments of the disclosure, the system 100 communicates with a client device 104 using an application protocol, such as hypertext transfer protocol (HTTP). In some embodiments, the system 100 provides a client device 104 with a user interface 140 accessed using a web browser 142 and displayed on a monitor and/or a mobile device. Web browser form input can be provided using a hypertext markup language (HTML) and/or extensible HTML (XHTML) format, and can provide navigation to other web pages (e.g., via hypertext links). The web browser 142 can also use other resources such as style sheets, scripts, images, and so forth.

In other embodiments, content is served to a client device 104 using another application protocol. For instance, a third-party tool provider 146 (e.g., a tool provider not operated and/or maintained by a system 100) can include content from a system 100 (e.g., embedded in a web page 144 provided by the third-party tool provider 146). It should be noted that a thin client configuration for the client device 104 is provided by way of example only and is not meant to limit the present disclosure. In other embodiments, the client device 104 is implemented as a thicker (e.g., fat, heavy, rich) client. For example, the client device 104 provides rich functionality independently of the system 100. In some embodiments, one or more cryptographic protocols are used to transmit information between a system 100 and a client device 104 and/or a third-party tool provider 146. Examples of such cryptographic protocols include, but are not necessarily limited to: a transport layer security (TLS) protocol, a secure sockets layer (SSL) protocol, and so forth. For instance, communications between a system 100 and a client device 104 can use HTTP secure (HTTPS) protocol, where HTTP protocol is layered on SSL and/or TLS protocol.

A system 100, including some or all of its components, can operate under computer control. For example, a processor 150 can be included with or in a system 100 to control the components and functions of systems 100 described herein using software, firmware, hardware (e.g., fixed logic circuitry), manual processing, or a combination thereof. The terms “controller,” “functionality,” “service,” and “logic” as used herein generally represent software, firmware, hardware, or a combination of software, firmware, or hardware in conjunction with controlling the systems 100. In the case of a software implementation, the module, functionality, or logic represents program code that performs specified tasks when executed on a processor (e.g., central processing unit (CPU) or CPUs). The program code can be stored in one or more computer-readable memory devices (e.g., internal memory and/or one or more tangible media), and so on. The structures, functions, approaches, and techniques described herein can be implemented on a variety of commercial computing platforms having a variety of processors.

A processor 150 provides processing functionality for the system 100 and can include any number of processors, micro-controllers, or other processing systems, and resident or external memory for storing data and other information accessed or generated by the system 100. The processor 150 can execute one or more software programs that implement techniques described herein. The processor 150 is not limited by the materials from which it is formed or the processing mechanisms employed therein and, as such, can be implemented via semiconductor(s) and/or transistors (e.g., using electronic integrated circuit (IC) components), and so forth.

The system 100 includes a memory 152. The memory 152 is an example of tangible, computer-readable storage medium that provides storage functionality to store various data associated with operation of the system 100, such as software programs and/or code segments, or other data to instruct the processor 150, and possibly other components of the system 100, to perform the functionality described herein. Thus, the memory 152 can store data, such as a program of instructions for operating the system 100 (including its components), and so forth. It should be noted that while a single memory 152 is described, a wide variety of types and combinations of memory (e.g., tangible, non-transitory memory) can be employed. The memory 152 can be integral with the processor 150, can comprise stand-alone memory, or can be a combination of both. The memory 152 can include, but is not necessarily limited to: removable and non-removable memory components, such as random-access memory (RAM), read-only memory (ROM), flash memory (e.g., a secure digital (SD) memory card, a mini-SD memory card, and/or a micro-SD memory card), magnetic memory, optical memory, universal serial bus (USB) memory devices, hard disk memory, external memory, and so forth. In implementations, the system 100 and/or the memory 152 can include removable integrated circuit card (ICC) memory, such as memory provided by a subscriber identity module (SIM) card, a universal subscriber identity module (USIM) card, a universal integrated circuit card (UICC), and so on.

The system 100 includes a communications interface 154. The communications interface 154 is operatively configured to communicate with components of the system 100. For example, the communications interface 154 can be configured to transmit data for storage in the system 100, retrieve data from storage in the system 100, and so forth. The communications interface 154 is also communicatively coupled with the processor 150 to facilitate data transfer between components of the system 100 and the processor 150 (e.g., for communicating inputs to the processor 150 received from a device communicatively coupled with the system 100). It should be noted that while the communications interface 154 is described as a component of a system 100, one or more components of the communications interface 154 can be implemented as external components communicatively coupled to the system 100 via a wired and/or wireless connection. The system 100 can also comprise and/or connect to one or more input/output (I/O) devices (e.g., via the communications interface 154), including, but not necessarily limited to: a display, a mouse, a touchpad, a keyboard, and so on.

The communications interface 154 and/or the processor 150 can be configured to communicate with a variety of different networks, including, but not necessarily limited to: a wide-area cellular telephone network, such as a 3G cellular network, a 4G cellular network, or a global system for mobile communications (GSM) network; a wireless computer communications network, such as a WiFi network (e.g., a wireless local area network (WLAN) operated using IEEE 802.11 network standards); an internet; the Internet; a wide area network (WAN); a local area network (LAN); a personal area network (PAN) (e.g., a wireless personal area network (WPAN) operated using IEEE 802.15 network standards); a public telephone network; an extranet; an intranet; and so on. However, this list is provided by way of example only and is not meant to limit the present disclosure. Further, the communications interface 154 can be configured to communicate with a single network or multiple networks across different access points.

Generally, any of the functions described herein can be implemented using hardware (e.g., fixed logic circuitry such as integrated circuits), software, firmware, manual processing, or a combination thereof. Thus, the blocks discussed in the above disclosure generally represent hardware (e.g., fixed logic circuitry such as integrated circuits), software, firmware, or a combination thereof. In the instance of a hardware configuration, the various blocks discussed in the above disclosure may be implemented as integrated circuits along with other functionality. Such integrated circuits may include all of the functions of a given block, system, or circuit, or a portion of the functions of the block, system, or circuit. Further, elements of the blocks, systems, or circuits may be implemented across multiple integrated circuits. Such integrated circuits may comprise various integrated circuits, including, but not necessarily limited to: a monolithic integrated circuit, a flip chip integrated circuit, a multichip module integrated circuit, and/or a mixed signal integrated circuit. In the instance of a software implementation, the various blocks discussed in the above disclosure represent executable instructions (e.g., program code) that perform specified tasks when executed on a processor. These executable instructions can be stored in one or more tangible computer readable media. In some such instances, the entire system, block or circuit may be implemented using its software or firmware equivalent. In other instances, one part of a given system, block or circuit may be implemented in software or firmware, while other parts are implemented in hardware.

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

What is claimed is:

1. A system for determining sales tax based upon inventory comprising:
a processor configured to receive inventory information associated with goods stocked by a merchant; and
a memory having computer executable instructions stored thereon, the computer executable instructions configured for execution by the processor to:
determine an amount of taxable sales made by the merchant based upon the inventory information; and
generate a tax form for the merchant based upon the determined amount of taxable sales made by the merchant.

2. The system as recited in claim 1, wherein the computer executable instructions are configured for execution by the processor to:
receive inventory information associated with the merchant's inventory at the beginning of a period;
receive inventory information associated with the merchant's inventory at the end of the period; and
determine an amount of taxable sales made by the merchant based, at least in part, upon the inventory information associated with the merchant's inventory at the beginning of a period and the inventory information associated with the merchant's inventory at the end of the period.

3. The system as recited in claim 1, wherein the computer executable instructions are configured for execution by the processor to receive sales information associated with sales made by the merchant.

4. The system as recited in claim 1, wherein the computer executable instructions are configured for execution by the processor to receive sales information associated with sales to the merchant.

5. The system as recited in claim 1, wherein the inventory information comprises a number of individual units of inventory and identifying information associated with the number of individual units of inventory.

6. The system as recited in claim 1, wherein the inventory information comprises a number of individual units of inventory and monetary value associated with the number of individual units of inventory.

7. The system as recited in claim 1, wherein the computer executable instructions are configured for execution by the processor to receive an inventory audit associated with the goods stocked by the merchant and compare the inventory audit to the inventory information associated with the goods stocked by the merchant to determine whether there is a discrepancy in the inventory information.

8. A non-transitory computer-readable storage medium having computer executable instructions configured to determine sales tax based upon inventory, the computer executable instructions comprising:
receiving, by a processor, inventory information associated with goods stocked by a merchant; and
determining, by the processor, an amount of taxable sales made by the merchant based upon the inventory information.

9. The computer-readable storage medium as recited in claim 8, wherein receiving inventory information associated with goods stocked by a merchant comprises:
receiving, by the processor, inventory information associated with the merchant's inventory at the beginning of a period; and
receiving, by the processor, inventory information associated with the merchant's inventory at the end of the period.

10. The computer-readable storage medium as recited in claim 8, wherein the computer executable instructions further comprise receiving sales information associated with sales made by the merchant.

11. The computer-readable storage medium as recited in claim 8, wherein the computer executable instructions further comprise receiving sales information associated with sales to the merchant.

12. The computer-readable storage medium as recited in claim 8, wherein the inventory information comprises a number of individual units of inventory and identifying information associated with the number of individual units of inventory.

13. The computer-readable storage medium as recited in claim 8, wherein the inventory information comprises a number of individual units of inventory and monetary value associated with the number of individual units of inventory.

14. The computer-readable storage medium as recited in claim 8, wherein the computer executable instructions further comprise receiving an inventory audit associated with the goods stocked by the merchant and comparing the inventory audit to the inventory information associated with the goods stocked by the merchant to determine whether there is a discrepancy in the inventory information.

15. A computer-implemented method for determining sales tax based upon inventory, the computer-implemented method comprising:
receiving, by a processor, inventory information associated with goods stocked by a merchant, the inventory information comprising inventory information associated with the merchant's inventory at the beginning of a period and inventory information associated with the merchant's inventory at the end of the period; and
causing the processor to determine an amount of taxable sales made by the merchant based upon the inventory information.

16. The computer-implemented method as recited in claim 15, further comprising receiving sales information associated with sales made by the merchant.

17. The computer-implemented method as recited in claim 15, further comprising receiving sales information associated with sales to the merchant.

18. The computer-implemented method as recited in claim 15, wherein the inventory information comprises a number of individual units of inventory and identifying information associated with the number of individual units of inventory.

19. The computer-implemented method as recited in claim 15, wherein the inventory information comprises a number of individual units of inventory and monetary value associated with the number of individual units of inventory.

20. The computer-implemented method as recited in claim 15, further comprising receiving an inventory audit associated with the goods stocked by the merchant and comparing the inventory audit to the inventory information associated with the goods stocked by the merchant to determine whether there is a discrepancy in the inventory information.
